(19) United States
(12) Patent Application Publication
(10) Pub. No.: US 2026/0319525 A1
(43) Pub. Date: Oct. 15, 2026

(54) DANGEROUS SITUATION RESPONSE SYSTEM USING A PLURALITY OF ROBOTS AND OPERATING METHOD THEREOF

(71) Applicants: Hyundai Motor Company, Seoul (KR); Kia Corporation, Seoul (KR)

(72) Inventor: Ji Min Han, Hwaseong (KR)

(21) Appl. No.: 19/316,579

(22) Filed: Sep. 2, 2025

(30) Foreign Application Priority Data
Apr. 11, 2025 (KR) 10-2025-0047596

(51) Int. Cl. G05D 1/698; G05D 105/55; G05D 105/85

(52) U.S. Cl. CPC G05D 1/6987; G05D 2105/55; G05D 2105/85

(57) ABSTRACT

Disclosed is a dangerous situation response system using a plurality of robots. The dangerous situation response system includes the plurality of robots respectively corresponding to a plurality of zones separated from each other to operate in the respectively corresponding zones, a robot management device that controls operation of each of the plurality of robots, and a control system that receives image data collected by at least one robot among the plurality of robots from the robot management device. The control system includes an event detection device that detects that a dangerous situation occurs in any one of the plurality of zones, a determination device that determines a situation in which the plurality of robots are able to collaborate with one another, and a distribution device that distributes a task to the at least one robot among the plurality of robots based on the determined result of the determination device.

### CROSS-REFERENCE TO RELATED APPLICATION

This application claims, under 35 U.S.C. § 119(a), the benefit of Korean Patent Application No. 10-2025-0047596, filed Apr. 11, 2025, in the Korean Intellectual Property Office, the entire contents of which are incorporated herein by reference.

### BACKGROUND

### (a) Technical Field

The present disclosure relates to a dangerous situation response system using a plurality of robots and an operating method thereof and, more particularly, to technologies for determining and responding to a dangerous situation which occurs in a specific zone using a plurality of patrol robots.

### (b) Description of the Related Art

With the increase in robots for performing different functions, and the increase in robot-friendly buildings in which a plurality of robots coexist, the importance of a technology for efficiently distributing tasks performed between the respective robots has increased. Particularly, research on a technology for efficiently distributing tasks performed by respective robots and controlling the respective robots to collaborate with one another to deal with a dangerous situation in real time, if there occurs the dangerous situation, such as intrusion of a suspicious person into a robot-friendly building, occurrence of a fire, or occurrence of an emergency patient, is needed.

The above matters disclosed in this section are merely for enhancement of understanding of the general background of the disclosure and should not be taken as an acknowledgement or any form of suggestion that the matters form the related art already known to a person skilled in the art.

### SUMMARY

The present disclosure has been made to solve the above-mentioned problems occurring in the prior art while advantages achieved by the prior art are maintained intact.

An aspect of the present disclosure provides a dangerous situation response system using a plurality of robots for allowing several patrol robots to collaborate with one another to efficiently respond to a dangerous situation which occurs in a specific zone.

Another aspect of the present disclosure provides an operating method of a dangerous situation response system using a plurality of robots for allowing several patrol robots to collaborate with one another to efficiently respond to a dangerous situation which occurs in a specific zone.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a dangerous situation response system using a plurality of robots may include the plurality of robots respectively corresponding to a plurality of zones separated from each other to operate in the respectively corresponding zones. a robot management device that controls operation of each of the plurality of robots, and a control system that receives image data collected by at least one robot among the plurality of robots from the robot management device. The control system may include an event detection device that detects that a dangerous situation occurs in any one of the plurality of zones based on the received image data, a determination device that determines a situation in which the plurality of robots are able to collaborate with one another based on data about current states of the plurality of robots, the data being received from the robot management device, and a distribution device that distributes a task to the at least one robot among the plurality of robots based on the determined result of the determination device.

In an embodiment, the robot management device may transmit data about a current location of the at least one robot among the plurality of robots to the determination device. The determination device may determine the situation in which the plurality of robots are able to collaborate with one another based on the received data about the current location of the robot.

In an embodiment, the robot management device may transmit data about a current remaining battery capacity of the at least one robot among the plurality of robots to the determination device. The determination device may determine the situation in which the plurality of robots are able to collaborate with one another based on the received data about the current remaining battery capacity of the robot.

In an embodiment, the robot management device may transmit data about a task of the at least one robot among the plurality of robots, the task being currently in progress, to the determination device. The determination device may determine the situation in which the plurality of robots are able to collaborate with one another based on the received data about the task of the robot, the task being currently in progress.

In an embodiment, the robot management device may receive the collected image data from each of the plurality of robots, may construct a database about a frequency at which face data present in the received image data appears in zones respectively corresponding to the plurality of robots, and may compare the face data stored in the database with face data recognized in real time by the at least one robot among the plurality of robots to respond to an object recognized by the at least one robot in a corresponding zone of the at least one robot.

In an embodiment, the robot management device may allow the at least one robot to request to register an ID, in response to that a frequency of appearance of the face data recognized in real time by the at least one robot, the frequency of appearance being identified from the database, is greater than or equal to a predetermined threshold.

In an embodiment, the robot management device may allow the at least one robot to transmit a warning message to the object and guide the object to register access, in response to that a frequency of appearance of the face data recognized in real time by the at least one robot, the frequency of appearance being identified from the database, is less than a predetermined threshold and is greater than “0”.

In an embodiment, the robot management device may transmit a notification signal to the control system and may determine an expected path of the object, in response to that a frequency of appearance of the face data recognized in real time by the at least one robot, the frequency of appearance being identified from the database, is “0”.

In an embodiment, the robot management device may determine whether there is another robot different from the at least one robot on the determined expected path of the object; and may transmit face data of the object to the other robot, in response to that it is determined that there is the other robot on the expected path, and request the other robot to follow the object and utter a warning message to the object.

In an embodiment, the robot management device may determine whether there is another robot different from the at least one robot on the determined expected path of the object and may allow the at least one robot to follow the object and utter a warning message to the object, in response to that it is determined that there is no other robot on the expected path.

According to another aspect of the present disclosure, an operating method of a dangerous situation response system using a plurality of robots may include providing a plurality of robots respectively corresponding to a plurality of zones separated from each other and operating in the respectively corresponding zones, controlling, by a robot management device, operation of each of the plurality of robots, collecting, by at least one robot among the plurality of robots, image data, transmitting, by the at least one robot, the image data to the robot management device, transmitting, by the robot management device, the image data to a control system, detecting, by an event detection device of the control system, that a dangerous situation occurs in any one of the plurality of zones based on the image data, determining, by a determination device of the control system, a situation in which the plurality of robots are able to collaborate with one another based on data about current states of the plurality of robots, the data being received from the robot management device, and distributing, by a distribution device of the control system, a task to the at least one robot among the plurality of robots based on the determined result of the determination device.

In an embodiment, the operating method may further include transmitting, by the robot management device, data about a current location of the at least one robot among the plurality of robots to the determination device. The determining of the situation in which the plurality of robots are able to collaborate with one another by the determination device may include determining the situation in which the plurality of robots are able to collaborate with one another based on the received data about the current location of the robot.

In an embodiment, the operating method may further include transmitting, by the robot management device, data about a current remaining battery capacity of the at least one robot among the plurality of robots to the determination device. The determining of the situation in which the plurality of robots are able to collaborate with one another by the determination device may include determining the situation in which the plurality of robots are able to collaborate with one another based on the received data about the current remaining battery capacity of the robot.

In an embodiment, the operating method may further include transmitting, by the robot management device, data about a task of the at least one robot among the plurality of robots, the task being currently in progress, to the determination device. The determining of the situation in which the plurality of robots are able to collaborate with one another by the determination device may include determining the situation in which the plurality of robots are able to collaborate with one another based on the received data about the task of the robot, the task being currently in progress.

In an embodiment, the operating method may further include constructing, by the robot management device, a database about a frequency at which face data present in the image data appears in a zone corresponding to the at least one robot, comparing, by the robot management device, the face data stored in the database with face data recognized in real time by the at least one robot, and responding, by the robot management device, to an object recognized by the at least one robot in a corresponding zone of the at least one robot, based on the compared result.

In an embodiment, the operating method may further include allowing, by the robot management device, the at least one robot to request to register an ID, in response to that a frequency of appearance of the face data recognized in real time by the at least one robot, the frequency of appearance being identified from the database, is greater than or equal to a predetermined threshold.

In an embodiment, the operating method may further include allowing, by the robot management device, the at least one robot to transmit a warning message to the object and guide the object to register access, in response to that a frequency of appearance of the face data recognized in real time by the at least one robot, the frequency of appearance being identified from the database, is less than a predetermined threshold and is greater than “0”.

In an embodiment, the operating method may further include transmitting, by the robot management device, a notification signal to the control system and determining, by the robot management device, an expected path of the object, in response to that a frequency of appearance of the face data recognized in real time by the at least one robot, the frequency of appearance being identified from the database, is “0”.

In an embodiment, the operating method may further include determining, by the robot management device, whether there is another robot different from the at least one robot on the determined expected path of the object, transmitting, by the robot management device, face data of the object to the other robot, in response to that it is determined that there is the other robot on the expected path, and requesting, by the robot management device, the other robot to follow the object and utter a warning message to the object.

In an embodiment, the operating method may further include determining, by the robot management device, whether there is another robot different from the at least one robot on the determined expected path of the object and allowing, by the robot management device, the at least one robot to follow the object and utter a warning message to the object, in response to that it is determined that there is the other robot on the expected path.

According to an aspect of the present disclosure, a dangerous situation response system is provided. The dangerous situation response system may comprise a plurality of robots respectively corresponding to a plurality of zones and configured to operate, respectively, in the plurality of zones. The plurality of zones may be separated from each other. The dangerous situation response system may comprise a robot management device configured to control operation of each of the plurality of robots and a control system configured to receive image data collected by at least one robot, among the plurality of robots, from the robot management device. The control system may comprise an event detection device configured to detect whether a dangerous situation has occurred in any one of the plurality of zones based on the received image data, a determination device configured to determine a situation in which the plurality of robots are able to collaborate with one another based on data about current states of the plurality of robots, the data being received from the robot management device, and a distribution device configured to distribute a task to the at least one robot, among the plurality of robots, based on the determined situation.

According to an exemplary embodiment, the robot management device may be configured to transmit data about a current location of the at least one robot, among the plurality of robots, to the determination device, and the determination device may be configured to determine the situation in which the plurality of robots are able to collaborate with one another based on the received data about the current location of the robot.

According to an exemplary embodiment, the robot management device may be configured to transmit data about a current remaining battery capacity of the at least one robot, among the plurality of robots, to the determination device, and the determination device may be configured to determine the situation in which the plurality of robots are able to collaborate with one another based on the received data about the current remaining battery capacity of the robot.

According to an exemplary embodiment, the robot management device may be configured to transmit data about a task of the at least one robot, among the plurality of robots, the task being currently in progress, to the determination device, and the determination device may be configured to determine the situation in which the plurality of robots are able to collaborate with one another based on the received data about the task of the robot, the task being currently in progress.

According to an exemplary embodiment, the robot management device may be configured to receive the collected image data from each of the plurality of robots, construct a database about a frequency at which face data present in the received image data appears in zones respectively corresponding to the plurality of robots, and compare the face data stored in the database with face data recognized in real time by the at least one robot among the plurality of robots to respond to an object recognized by the at least one robot in a corresponding zone of the at least one robot.

According to an exemplary embodiment, the robot management device may be configured to allow the at least one robot to request to register an ID in response to a frequency of appearance of the face data, recognized in real time by the at least one robot, the frequency of appearance being identified from the database and greater than or equal to a predetermined threshold.

According to an exemplary embodiment, the robot management device may be configured to allow the at least one robot to transmit a warning message to the object and guide the object to register access, in response to a frequency of appearance of the face data, recognized in real time by the at least one robot, the frequency of appearance being identified from the database, less than a predetermined threshold, and greater than “0”.

According to an exemplary embodiment, the robot management device may be configured to transmit a notification signal to the control system and determine an expected path of the object, in response to a frequency of appearance of the face data, recognized in real time by the at least one robot, the frequency of appearance being identified from the database as “0”.

According to an exemplary embodiment, the robot management device may be configured to determine whether there is another robot, different from the at least one robot, on the determined expected path of the object, transmit face data of the object to the other robot, in response to it being determined that the other robot is on the expected path, and request the other robot to follow the object and utter a warning message to the object.

According to an exemplary embodiment, the robot management device may be configured to determine whether there is another robot different from the at least one robot on the determined expected path of the object, and allow the at least one robot to follow the object and utter a warning message to the object, in response to it being determined that there is no other robot on the expected path.

According to an aspect of the present disclosure, an operating method of a dangerous situation response system is provided. The operating method may comprise providing a plurality of robots respectively corresponding to a plurality of zones and operating in the respectively corresponding zones. The plurality of zones may be separated from each other. The operating method may comprise controlling, by a robot management device, operation of each of the plurality of robots, collecting, by at least one robot among the plurality of robots, image data, transmitting, by the at least one robot, the image data to the robot management device, transmitting, by the robot management device, the image data to a control system, detecting, by an event detection device of the control system, whether a dangerous situation has occurred in any one of the plurality of zones, based on the image data, determining, by a determination device of the control system, a situation in which the plurality of robots are able to collaborate with one another based on data about current states of the plurality of robots, the data being received from the robot management device, and distributing, by a distribution device of the control system, a task to the at least one robot, among the plurality of robots, based on the determined situation.

According to an exemplary embodiment, the operating method may comprise transmitting, by the robot management device, data about a current location of the at least one robot among the plurality of robots to the determination device. The determining of the situation in which the plurality of robots are able to collaborate with one another by the determination device may comprise determining the situation in which the plurality of robots are able to collaborate with one another based on the received data about the current location of the robot.

According to an exemplary embodiment, the operating method may comprise transmitting, by the robot management device, data about a current remaining battery capacity of the at least one robot among the plurality of robots to the determination device. The determining of the situation in which the plurality of robots are able to collaborate with one another by the determination device may comprise determining the situation in which the plurality of robots are able to collaborate with one another based on the received data about the current remaining battery capacity of the robot.

According to an exemplary embodiment, the operating method may comprise transmitting, by the robot management device, data about a task of the at least one robot among the plurality of robots, the task being currently in progress, to the determination device. The determining of the situation in which the plurality of robots are able to collaborate with one another by the determination device may comprise determining the situation in which the plurality of robots are able to collaborate with one another based on the received data about the task of the robot, the task being currently in progress.

According to an exemplary embodiment, the operating method may comprise constructing, by the robot management device, a database about a frequency at which face data present in the image data appears in a zone corresponding to the at least one robot, comparing, by the robot management device, the face data stored in the database with face data recognized in real time by the at least one robot, and responding, by the robot management device, to an object recognized by the at least one robot in a corresponding zone of the at least one robot, based on the compared result.

According to an exemplary embodiment, the operating method may comprise allowing, by the robot management device, the at least one robot to request to register an ID, in response to a frequency of appearance of the face data, recognized in real time by the at least one robot, the frequency of appearance being identified from the database and greater than or equal to a predetermined threshold.

According to an exemplary embodiment, the operating method may comprise allowing, by the robot management device, the at least one robot to transmit a warning message to the object and guide the object to register access, in response to the frequency of appearance of the face data recognized in real time by the at least one robot, the frequency of appearance being identified from the database, less than a predetermined threshold, and greater than “0”.

According to an exemplary embodiment, the operating method may comprise transmitting, by the robot management device, a notification signal to the control system and determining, by the robot management device, an expected path of the object, in response to a frequency of appearance of the face data, recognized in real time by the at least one robot, the frequency of appearance being identified from the database as “0”.

According to an exemplary embodiment, the operating method may comprise determining, by the robot management device, whether there is another robot, different from the at least one robot, on the determined expected path of the object, transmitting, by the robot management device, face data of the object to the other robot, in response to it being determined that there is the other robot on the expected path, and requesting, by the robot management device, the other robot to follow the object and utter a warning message to the object.

According to an exemplary embodiment, the operating method may comprise determining, by the robot management device, whether there is another robot, different from the at least one robot, on the determined expected path of the object, and allowing, by the robot management device, the at least one robot to follow the object and utter a warning message to the object, in response to it being determined that there is no other robot on the expected path.

According to an aspect of the present disclosure, a dangerous situation response system is provided. The dangerous situation response system may comprise a plurality of robots respectively corresponding to a plurality of zones and configured to operate, respectively, in the plurality of zones. The plurality of zones may be separated from each other. The dangerous situation response system may comprise a computing device comprising a processor and a memory. The memory may be configured to store instructions that, when executed by the processor, are configured to cause the processor to control operation of each of the plurality of robots, receive image data collected by at least one robot, among the plurality of robots, detect whether a dangerous situation has occurred in any one of the plurality of zones based on the received image data, determine a situation in which the plurality of robots are able to collaborate with one another based on data about current states of the plurality of robots, and distribute a task to the at least one robot, among the plurality of robots, based on the determined situation.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram illustrating a configuration of a dangerous situation response system using a plurality of robots, according to an exemplary embodiment of the present disclosure.

FIG. 2 illustrates a flow diagram for describing an operating method of a dangerous situation response system using a plurality of robots, according to an exemplary embodiment of the present disclosure.

FIG. 3 illustrates a drawing for describing a determination device and a distribution device of FIG. 2.

FIG. 4 illustrates a drawing for describing zones patrolled by a plurality of robots in a dangerous situation response system using a plurality of robots, according to an exemplary embodiment of the present disclosure.

FIGS. 5 and 6 illustrate flowcharts for describing an operating method of a dangerous situation response system using a plurality of robots, according to an exemplary embodiment of the present disclosure.

FIG. 7 illustrates a drawing for describing in detail S211 to S217 of FIG. 6.

FIG. 8 illustrates a flowchart for describing an operating method of a dangerous situation response system using a plurality of robots, according to an exemplary embodiment of the present disclosure.

FIGS. 9, 10, and 11 illustrate drawings for describing in detail S218 of FIG. 8.

FIG. 12 illustrates a flowchart for describing an operating method of a dangerous situation response system using a plurality of robots, according to another exemplary embodiment of the present disclosure.

FIG. 13 illustrates a drawing for describing in detail S303 of FIG. 12.

FIG. 14 illustrates a flowchart for describing an operating method of a dangerous situation response system using a plurality of robots, according to another exemplary embodiment of the present disclosure.

FIG. 15 illustrates a drawing for describing in detail S411 of FIG. 14.

FIG. 16 illustrates a flowchart for describing an operating method of a dangerous situation response system using a plurality of robots, according to another exemplary embodiment of the present disclosure.

FIG. 17 illustrates a drawing for describing an emergency severity score in a method of FIG. 16.

FIG. 18 illustrates example elements of a computing device, according to an exemplary embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

The following Detailed Description is merely provided by way of example and not of limitation. Furthermore, there is no intention to be bound by any expressed or implied theory presented in the preceding background or in the following Detailed Description.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

It will be understood that, although the terms “first”, “second”, etc. may be used herein to describe various elements, these elements should not be limited by these terms. These terms are only used to distinguish one element from another.

The suffixes “module” and “unit” of elements herein are used for convenience of description and thus may be used interchangeably and do not have any distinguishable meanings or functions.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Any number of components or a variety of components of any one of the configurations disclosed in the present disclosure may be included in the present disclosure. Such components may include any combination of characterized parts disclosed in the present disclosure, and may be arranged to constitute any one of various configurations disclosed in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, embodiments including various characterized parts having various arrangements will be described with reference to the accompanying drawings.

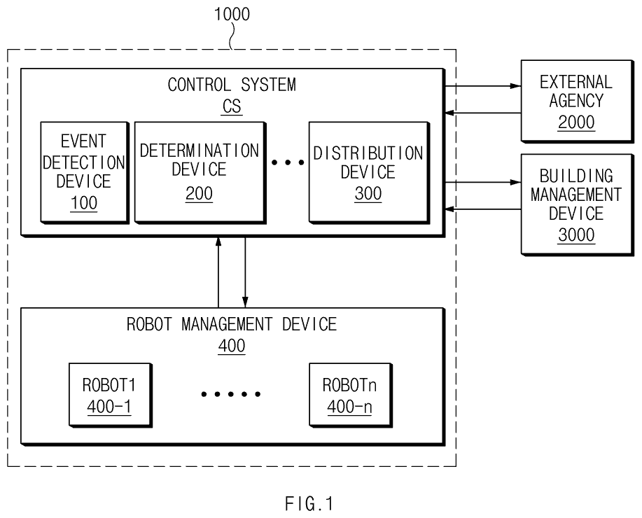

Hereinafter, embodiments of the present disclosure will be described in detail with reference to FIGS. 1 to 17.

FIG. 1 is a block diagram illustrating a configuration of a dangerous situation response system using a plurality of robots, according to an exemplary embodiment of the present disclosure.

Referring to FIG. 1, a dangerous situation response system using a plurality of robots (hereinafter referred to as a “dangerous situation response system”) 1000 may comprise a plurality of robots 400-1 to 400-n, a robot management device 400, and a control system CS (here, n is a natural number of 2 or more).

The plurality of robots 400-1 to 400-n may comprise robots configured to detect a dangerous situation (hereinafter referred to as an “event”) while patrolling specific zones and responding to the dangerous situation. For example, each of the plurality of robots 400-1 to 400-n may be configured to patrol the interior of each of a plurality of zones separated from each other in the interior of one building. In other words, the plurality of robots 400-1 to 400-n which patrol the interior of the one building may correspond to different zones in the interior of the one building, respectively. However, embodiments of the present disclosure are not limited thereto. The plurality of robots 400-1 to 400-n may comprise robots configured to patrol a certain zone outside one building, rather than the interior of the one building.

The robot management device 400 may be configured to control operation of the plurality of robots 400-1 to 400-n. In detail, the robot management device 400 may be configured to receive data from the control system CS and may be configured to control the operation of the plurality of robots 400-1 to 400-n based on the data. Furthermore, the robot management device 400 may be configured to transmit data detected by the plurality of robots 400-1 to 400-n to the control system CS, such that the control system CS detects an event which occurs in zones (hereinafter referred to as “control zones”) patrolled by the plurality of robots 400-1 to 400-n and responds to the event.

The control system CS may be configured to manage and control a dangerous situation which occurs in the control zone based on the data sensed by the plurality of robots 400-1 to 400-n, which is received from the robot management device 400. For example, the control system CS may be configured to receive image data collected by the plurality of robots 400-1 to 400-n while the plurality of robots 400-1 to 400-n patrol the interior of the control zone from the robot management device 400. The control system CS may correspond to an event which occurs in the control zone based on the received image data.

The control system CS may comprise an event detection device 100, a determination device 200, and a distribution device 300. The event detection device 100 may be configured to detect the dangerous situation which occurs in the control zone based on the data received from the robot management device 400. A type of dangerous situation which occurs in the control zone may comprise, for example, a situation in which a suspicious person appears, a situation in which a fire occurs, a situation in which an emergency patient occurs, or the like.

However, embodiments of the present disclosure are not limited thereto. A type of event (e.g., a type of dangerous situation) may vary according to a type of the control zone. For example, if the control zone is a parking lot, the control system CS may be configured to detect an illegal parking and stopping situation which occurs in the control zone and may be configured to respond to the illegal parking and stopping situation. According to an exemplary embodiment, the type of event which occurs in the control zone may comprise a fly-tipping situation, entry into no-go area, or the like.

The determination device 200 may be configured to determine a situation in which the plurality of robots 400-1 to 400-n are able to collaborate with one another based on the data received from the event detection device 100. For example, the determination device 200 may be configured to receive a control notification from the event detection device 100. According to an exemplary embodiment, the control notification transmitted to the determination device 200 by the event detection device 100 may comprise data about a type of an event which occurs in the control zone, a type of a robot which patrols a zone where the event occurs, or a severity degree of the dangerous situation which occurs.

The determination device 200 may be configured to identify current locations of the plurality of robots 400-1 to 400-n, a remaining battery capacity of each of the plurality of robots 400-1 to 400-n, a type of a task which is current in progress by each of the plurality of robots 400-1 to 400-n, or the like. The determination device 200 may be configured to determine whether the plurality of robots 400-1 to 400-n are able to collaborate with one another based on the identified result. If it is determined that the plurality of robots 400-1 to 400-n are able to collaborate with one another, the determination device 200 may be configured to determine a scenario in which the plurality of robots 400-1 to 400-n are able to collaborate with one another. The determination device 200 may be configured to transmit the determined result to the distribution device 300.

The distribution device 300 may be configured to distribute a task to each of the plurality of robots 400-1 to 400-n to resolve the dangerous situation which occurs in the control zone based on the result of determining the situation in which the plurality of robots 400-1 to 400-n are able to collaborate with one another, which is received from the determination device 200. For example, the distribution device 300 may be configured to distribute a task for communicating with an external agency 2000 to any one of the plurality of robots 400-1 to 400-n. Thus, the distribution device 300 may be configured to connect the robot with the external agency 2000. A type of the external agency 2000 may comprise a fire station, a police station, a hospital, or the like for responding to the dangerous situation which occurs in the control zone. Furthermore, the distribution device 300 may be configured to distribute a task for communicating with a building management device 3000 to any one of the plurality of robots 400-1 to 400-n. Thus, the distribution device 300 may be configured to connect the robot with the building management device 3000. A type of the building management device 3000 may comprise a CCTV, a swing gate, an elevator management device, or the like for managing a building in response to the dangerous situation which occurs in the control zone.

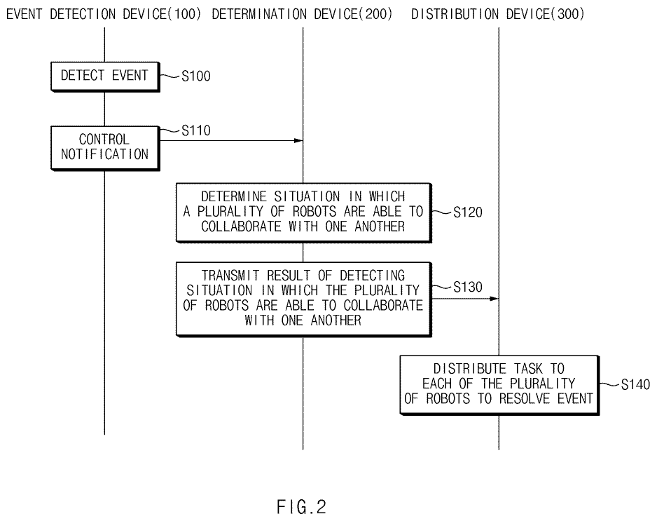

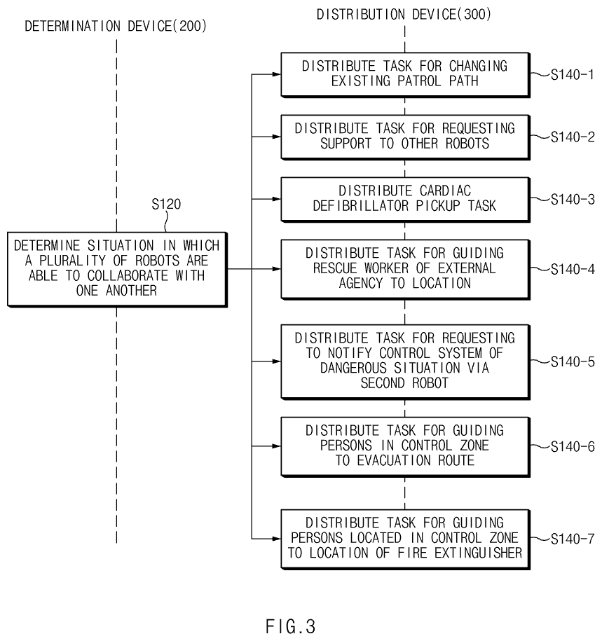

FIG. 2 is a flow diagram for describing an operating method of a dangerous situation response system using a plurality of robots, according to an exemplary embodiment of the present disclosure. FIG. 3 is a drawing for describing a determination device and a distribution device of FIG. 2. Hereinafter, a description will be given of a method for responding to an event which occurs in a control zone based on data received from a robot management device 400 in a control system CS with reference to FIGS. 2 and 3.

First of all, in S100, an event detection device 100 may be configured to detect an event which occurs in a control zone based on data sensed by a plurality of robots 400-1 to 400-n from the robot management device 400. Next, in S110, the event detection device 100 may be configured to transmit a control notification including information about the detected event to a determination device 200. In S120, the determination device 200 may be configured to receive the control notification from the event detection device 100 and may be configured to determine a situation in which the plurality of robots 400-1 to 400-n are able to collaborate with one another based on the control notification. Next, in S130, the determination device 200 may be configured to transmit the result of detecting the situation in which the plurality of robots 400-1 to 400-n are able to collaborate with one another to a distribution device 300. In S140, the distribution device 300 may be configured to receive data about the result of determining the situation which the plurality of robots 400-1 to 400-n are able to collaborate with one another from the determination device 200 and may distribute a task to each of the plurality of robots 400-1 to 400-n to resolve the event which occurs in the control zone based on the data.

The determination device 200 may be configured to generate various scenarios in which the plurality of robots 400-1 to 400-n are able to collaborate with one another based on information about the event which occurs in the control zone and information about current locations of the plurality of robots 400-1 to 400-n, remaining battery capacities of the plurality of robots 400-1 to 400-n, types of tasks which are currently in progress by the plurality of robots 400-1 to 400-n, or the like and may select and transmit the best scenario for responding to a dangerous situation among the various scenarios to the distribution device 300. The distribution device 300 may be configured to distribute a task to each of the plurality of robots 400-1 to 400-n based on the scenario received from the determination device 200.

For example, if there is a need for collaboration among the plurality of robots 400-1 to 400-n to respond to the dangerous situation, the distribution device 300 may be configured to distribute a task for changing an existing patrol path to at least one of the plurality of robots 400-1 to 400-n in S140-1 or may distribute a task for requesting support to other robots in S140-2. For example, if the determination device 200 determines that an emergency patient occurs in the control zone, the distribution device 300 may be configured to distribute a cardiac defibrillator pickup task to at least one of the plurality of robots 400-1 to 400-n based on the determined result received from the determination device 200 in S140-3 and may distribute a task for guiding a rescue worker of an external agency 2000 to a location where the emergency patient occurs in S140-4.

Furthermore, if a dangerous situation occurs in a zone patrolled by at least one (hereinafter referred to as a “first robot”) of the plurality of robots 400-1 to 400-n and the first robot should respond to the dangerous situation, in S140-5, the distribution device 300 may be configured to distribute a task for requesting to notify a control system CS of the dangerous situation via a second robot different from the first robot to the first robot.

Furthermore, if the determination device 200 determines that a fire occurs in the control zone, the distribution device 300 may be configured to distribute a task for guiding persons in the control zone to an evacuation route to at least one of the plurality of robots 400-1 to 400-n based on the determined result received from the determination device 200 in S140-6 and may be configured to distribute a task for guiding the persons located in the control zone to a location of a fire extinguisher in S140-7. However, the task distributed by the distribution device 300 described with reference to FIG. 3 is exemplified. The distribution device 300 may be configured to distribute various tasks according to an embodiment to each of the plurality of robots 400-1 to 400-n depending on a type of a dangerous situation based on the determined result received from the determination device 200.

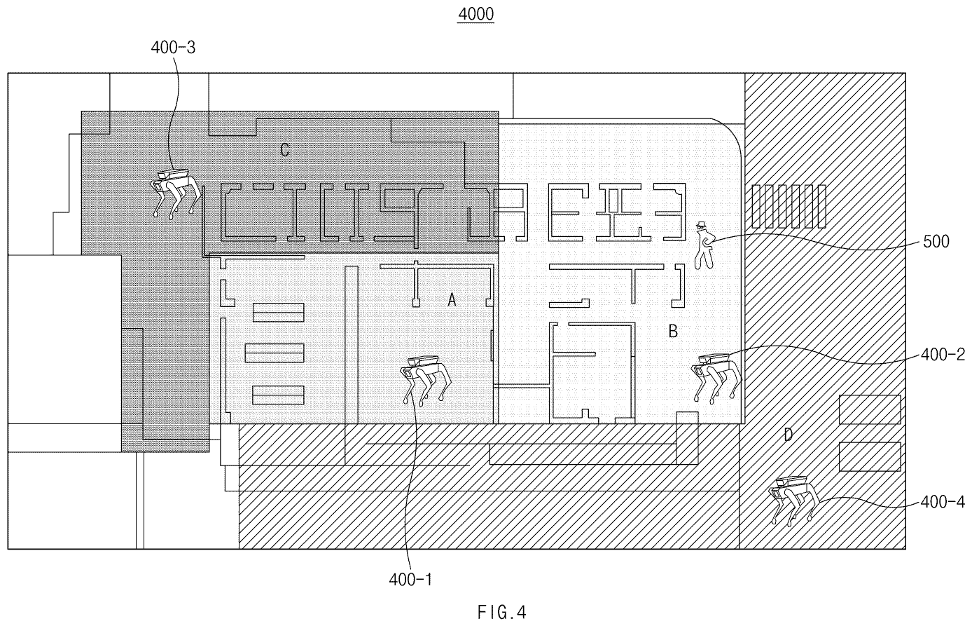

FIG. 4 is a drawing for describing zones patrolled by a plurality of robots in a dangerous situation response system using a plurality of robots, according to an exemplary embodiment of the present disclosure.

FIG. 4 is a drawing for describing respective zones patrolled by a plurality of robots 400-1 to 400-4, if a dangerous situation in which a suspicious person 500 appears occurs in a control zone 4000. Referring to FIG. 4, the control zone 4000 may be divided into a plurality of zones A, B, C, and D which are separated from each other. A plurality of robots 400-1 to 400-n which patrol the control zone 4000 may usually patrol only their own zones. For example, usually, the robot 400-1 may patrol zone A, the robot 400-2 may patrol zone B, the robot 400-3 may patrol zone C, and the robot 400-4 may patrol zone D.

However, if the dangerous situation occurs, the plurality of robots 400-1 to 400-4 may be configured to move to other zones rather than their own zones. For example, if the suspicious person 500 appears in zone B as shown in FIG. 4, a distribution device 300 may be configured to distribute tasks to the plurality of robots 400-1 to 400-4 such that the plurality of robots 400-1 to 400-4 collaborate with one other to respond to a dangerous situation in which the suspicious person 500 appears. If the other robots 400-1, 400-3, and 400-4 rather than the robot 400-2 which previously takes charge of zone B needs to move to zone B, depending on types of the tasks distributed by the distribution device 300, a robot management device 400 may be configured to control the other robots 400-1, 400-3, and 400-4 to move to zone B under control of the distribution device 300. However, embodiments of the present disclosure are not limited thereto. In some embodiments, the distribution device 300 may be configured to distribute a task for requesting support from the other robots 400-1, 400-3, and 400-4 to the robot 400-2 which is patrolling the zone where a suspicious person appears and the other robots 400-1, 400-3, and 400-4 may move to zone B depending on the request.

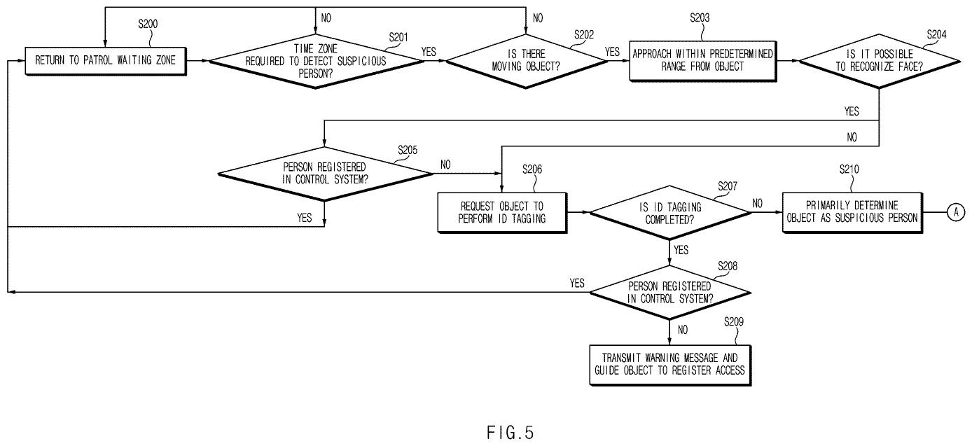

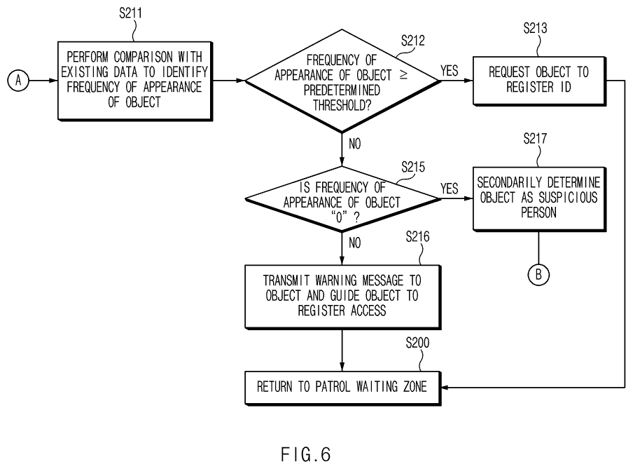

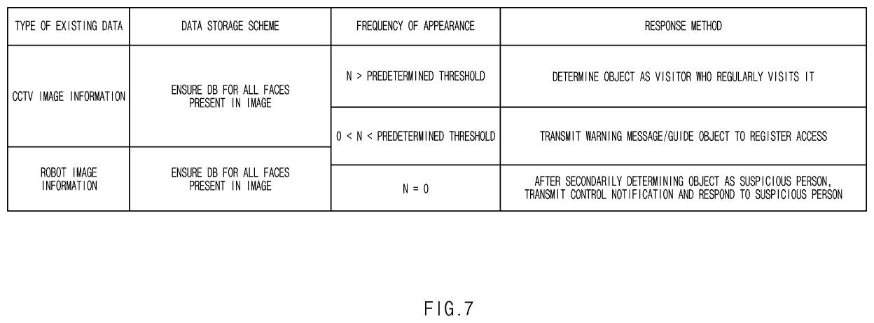

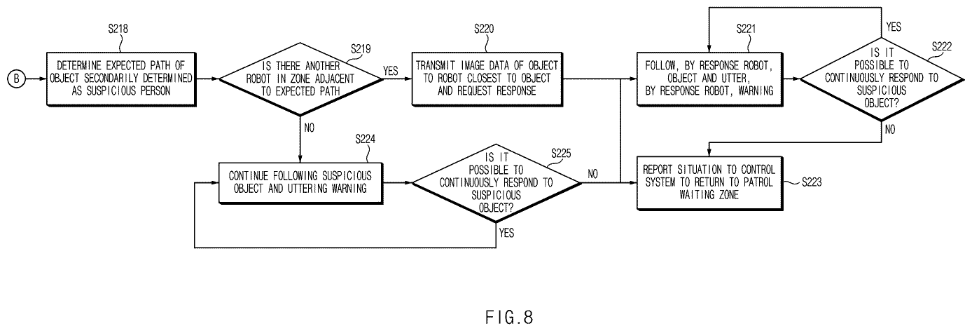

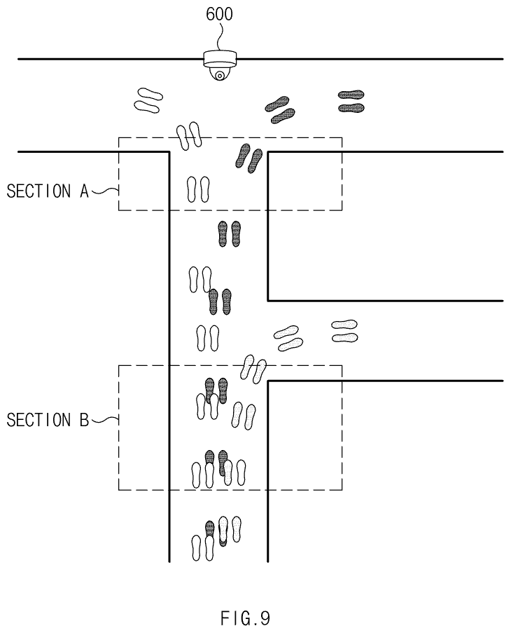

FIGS. 5 and 6 illustrate flowcharts for describing an operating method of a dangerous situation response system using a plurality of robots, according to an exemplary embodiment of the present disclosure. FIG. 7 illustrates a drawing for describing in detail S211 to S217 of FIG. 6. FIG. 8 is a flowchart for describing an operating method of a dangerous situation response system using a plurality of robots, according to an exemplary embodiment of the present disclosure. FIGS. 9 to 11 are drawings for describing in detail S218 of FIG. 8.

Hereinafter, a description will be given of a method in which a dangerous situation response system 1000 operates if a suspicious person appears in a control zone with reference to FIGS. 5 to 11.

First of all, referring to FIG. 5, in S201, a robot management device 400 may be configured to determine whether a current time zone is a time zone required to detect a suspicious person in a control zone. For example, a control system CS may be configured to set a time zone when there is on person in the control zone, for example, from the evening to the morning of the next day, to the time zone required to detect the suspicious person in the control zone. If it is determined that the current time zone is not the time zone required to detect the suspicious person (S201—NO), in S200, the robot management device 400 may be configured to control a plurality of robots 400-1 to 400-n to return to a patrol waiting zone.

If it is determined that the current time zone is the time zone required to detect the suspicious person (S201—YES), in S202, the robot management device 400 may be configured to determine whether there is a moving object in the control zone. If it is determined that there is no moving object in the control zone based on data received from the plurality of robots 400-1 to 400-n (S202—NO), in S200, the robot management device 400 may be configured to control the plurality of robots 400-1 to 400-n to return to the patrol waiting zone.

If it is determined that there is the moving object in the control zone based on the data received from the plurality of robots 400-1 to 400-n (S202—YES), in S203, the robot management device 400 may be configured to control a robot corresponding to the zone where there is the object among the plurality of robots 400-1 to 400-n to approach within a predetermined range from the object. Next, the robot may transmit data obtained by sensing a face of the object to the robot management device 400. In S204, the robot management device 400 may be configured to determine whether it is possible to recognize the face based on the received data.

If it is determined that it is possible to recognize the face (S204—YES), in S205, the robot management device 400 may be configured to determine whether the object with the face is a person registered in the control system CS. If it is determined that the object is the person registered in the control system CS (S205—YES), in S200, the robot management device 400 may be configured to control the plurality of robots 400-1 to 400-n to return to the patrol waiting zone.

Meanwhile, if it is determined that it is impossible to recognize the face (S204—NO), in S206, the robot management device 400 may be configured to control a robot which patrols the control zone to request the object to perform ID tagging. Each of the plurality of robots 400-1 to 400-n which patrol the control zone may be loaded with a tagging device capable of tagging an ID. The object may tag the owned ID on the tagging device of the robot. Next, in S207, the robot management device 400 may be configured to determine whether the ID tagging of the object on the tagging device is completed. If it is determined that the object completes the ID tagging on the tagging device of the robot (S207—YES), in S208, the robot management device 400 may be configured to determine whether the person is the person registered in the control system CS. If it is determined that the object is the person registered in the control system CS (S208—YES), in S200, the robot management device 400 may be configured to control the plurality of robots 400-1 to 400-n to return to the patrol waiting zone.

If determining that the object does not complete the ID tagging on the tagging device of the robot (S207—NO), in S210, the robot management device 400 may be configured to primarily determine the object as a suspicious person. Next, in S211, the robot management device 400 may be configured to perform comparison with existing data to identify a frequency of appearance of the object. Next, in S212, the robot management device 400 may be configured to determine whether the frequency of appearance of the object is greater than or equal to a predetermined threshold. If it is determined that the frequency of appearance of the object is greater than or equal to the predetermined threshold (S212—YES), in S213, the robot management device 400 may be configured to determine that the object is not finally the suspicious person to request the object to register his or her ID. Thereafter, in S200, the robot management device 400 may be configured to control the plurality of robots 400-1 to 400-n to return to the patrol waiting zone.

If it is determined that the frequency of appearance of the object is not greater than or equal to the predetermined threshold (S212—NO), in S215, the robot management device 400 may be configured to determine whether the frequency of appearance of the object is “0”. At this time, if it is determined that the frequency of appearance of the object is not “0” (S215—NO), in S216, the robot management device 400 may be configured to control a robot which patrols a zone where the object is detected to transmit a warning message to the object and guide the object to register access. Next, in S200, the robot management device 400 may be configured to control the plurality of robots 400-1 to 400-n to return to the patrol waiting zone.

Meanwhile, if it is determined that the frequency of appearance of the object is “0” (S215—YES), in S217, the robot management device 400 may be configured to secondarily determine the object as the suspicious person.

Referring together to FIG. 7, existing data compared with face data of the object primarily determined as the suspicious person sensed by the robot by the robot management device 400 in S211 may comprise CCTV image information or robot image information.

The CCTV image information may comprise image data obtained from a CCTV installed in the control zone. A building management device 3000 may be configured to transmit the CCTV image information to the robot management device 400 via the control system CS. The building management device 3000 may be configured to ensure image data for all faces which are present in the image captured by the CCTV installed in the control zone to construct a database.

The robot image information may be image data obtained as the plurality of robots 400-1 to 400-n which patrol the control zone 4000 sense faces of objects which are present within a predetermined range while patrolling their own zones. The robot management device 400 may be configured to ensure image data for all faces which are present in the image data sensed by each of the plurality of robots 400-1 to 400-n to construct a database.

The robot management device 400 may be configured to compare the CCTV image information and the robot image information with the image data of the object sensed by the robot to compare frequencies of appearance of the object in the CCTV image information and the robot image information with a predetermine threshold. If both the frequency of appearance of the object in the CCTV image information and the frequency of appearance of the object in the robot image information are greater than or equal to the predetermined threshold as a result of the comparison, in S213, the robot management device 400 may be configured to determine the object as a person which regularly visits the control zone and may request the object to register his or her ID.

Alternatively, if both the frequency of appearance of the object in the CCTV image information and the frequency of appearance of the object in the robot image information are greater than “0” and are less than the predetermined threshold as a result of the comparison, in S216, the robot management device 400 may be configured to control the robot which patrols the zone where the object is detected to transmit a warning message to the object and guide the object to register access.

Alternatively, if both the frequency of appearance of the object in the CCTV image information and the frequency of appearance of the object in the robot image information are “0” as a result of the comparison, in S217, the robot management device 400 may be configured to secondarily determine the object as a suspicious person, may transmit a control notification to the control system CS, and may be configured to perform a process corresponding to the suspicious person.

Next, referring to FIG. 8, in S218, the control system CS may be configured to determine an expected path of the object secondarily determined as the suspicious person. Hereinafter, a description will be given of the method for determining the expected path of the object secondarily determined as the suspicious person in the control system CS with reference to FIGS. 9 to 11.

First of all, a CCTV 600 may be installed in the control zone. The control system CS may be configured to construct a database of step trajectories of persons who usually pass through the control zone based on CCTV image information received from the building management device 3000. For example, as shown in FIG. 9, there may be section A and section B, each of which includes forked road, in the control zone. The control system CS may be configured to match a change in X- and Y-axis coordinates of a step trajectory of a person who passes through section A and section B, each of which includes the forked road, with a direction in which the person finally progresses on the forked road to construct a training database. The control system CS may be configured to determine a next expected path of the object secondarily determined as the suspicious person based on the constructed training database.

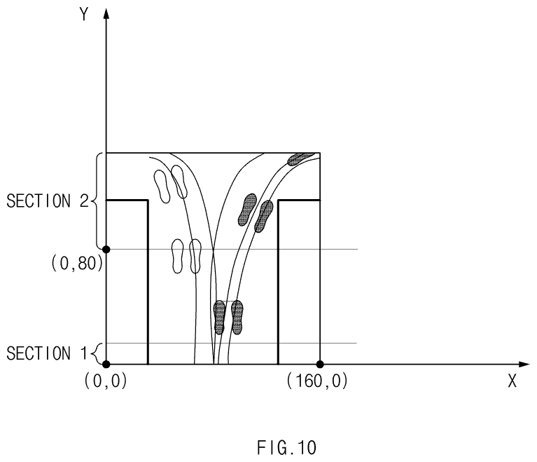

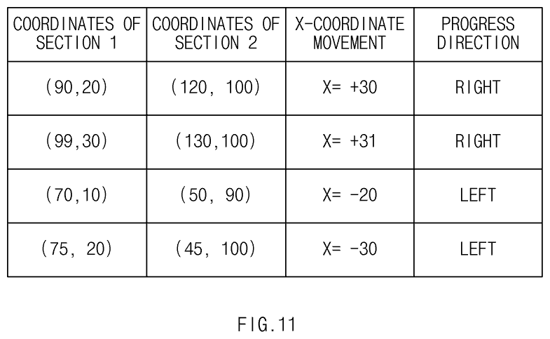

Hereinafter, a description will be given of a method for constructing a database of a step trajectory of a person who passes through section A where there is a forked road in the control system CS with reference to FIGS. 10 and 11. Referring to FIG. 10, section A may include section 1 and section 2. The person who passes through section A may first pass through section 1 and may then pass through section 2. Section 1 may fail to include the forked road and section 2 may include the forked road.

Referring together to FIG. 11, the control system CS may be configured to record (X, Y) coordinates of a step trajectory of a person who sequentially pass through section 1 and section 2 via CCTV image information and may be configured to calculate a variance in in X-coordinate value of the step trajectory in section 2 compared to an X-coordinate value of the step trajectory in section 1. In other words, if the person moves in a longitudinal direction (i.e., a Y-axis direction), the control system CS may be configured to track a movement direction along the X-axis of the step trajectory of the person. However, embodiments of the present disclosure are not limited thereto. If the person moves in a lateral direction (i.e., an X-axis direction), the control system CS may be configured to track a movement direction along the Y-axis of the step trajectory of the person.

For example, if the amount of movement along the X-axis of the step trajectory of any object increases, the control system CS may be configured to expect the object to move in a right direction (i.e., the X-axis direction). On the other hand, if the amount of movement along the X-axis of the step trajectory of any object decreases, the control system CS may be configured to expect the object to move in a left direction (i.e., an opposite direction of the X-axis).

Referring again to FIG. 8, after determining the expected path of the object secondarily determined as the suspicious person, in S219, the control system CS may be configured to allow the robot management device 400 to determine whether there is another robot except for the robot which directly detects the object (hereinafter referred to as a “sensing robot”) in a zone adjacent to the expected path.

If determining that there is the robot in the zone adjacent to the expected path (S219—YES), in S220, the robot management device 400 may be configured to transmit image data of the object to a robot closest to the object (hereinafter referred to as a “response robot”) among robots which are present in the zone adjacent to the expected path of the object and may request response from the response robot. Next, in S221, the response robot which receives the image data and the response request may follow the object and may utter a warning. Next, in S222, the response robot may be configured to determine whether it is possible to continuously respond to a suspicious object. If determining that it is possible to continuously respond to the suspicious object (S222—YES), in S221, the response robot may be configured to continue following the object and uttering the warning.

On the other hand, if determining that it is impossible to continuously respond to the suspicious object or determining that the suspicious object leaves (S222—NO), in S223, the response robot may be configured to report a situation to the control system CS via the robot management device 400 to return to a patrol waiting zone.

Meanwhile, if determining that there is no robot in the zone adjacent to the expected path (S219—NO), the robot management device 400 may be configured to allow the sensing robot to directly respond to the suspicious object to follow the object and utter a warning. Next, in S225, the sensing robot may be configured to determine whether it is possible to continuously respond to the suspicious object. If determining that it is possible to continuously respond as a result of the determination, in S224, the sensing robot may be configured to continue following the suspicious object and uttering the warning. On the other hand, if determining that it is impossible to continuously respond to the suspicious object or that the suspicious object leaves (S225—NO), in S223, the sensing robot may be configured to report a situation to the control system CS via the robot management device 400 to return to the patrol waiting zone.

As such, the dangerous situation response system 1000, according to an exemplary embodiment of the present disclosure, may be configured to determine and respond to a risk level which occurs in the control zone by means of one patrol robot based on past monitoring data (e.g., CCTV image information, robot image information, or the like). At this time, the dangerous situation response system 1000 may be configured to allow the plurality of robots to collaborate with one another to respond and may accurately determine a dangerous situation which occurs in the control zone using real-time control zone management data, such as CCTV image information, and image data collected by the patrol robot.

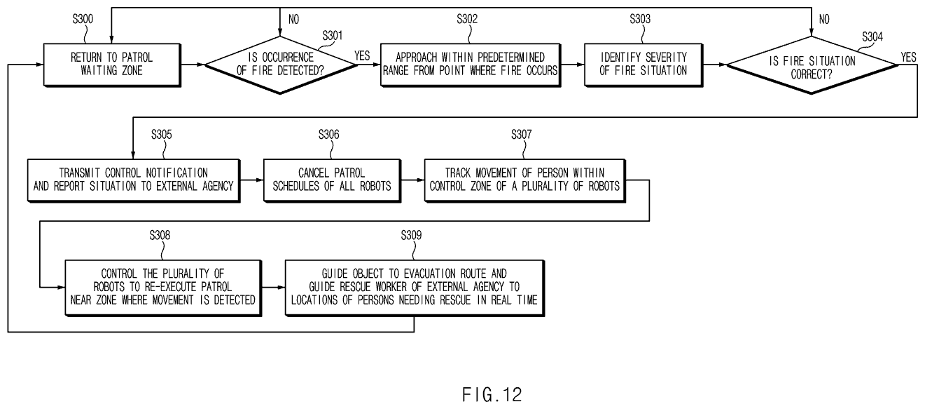

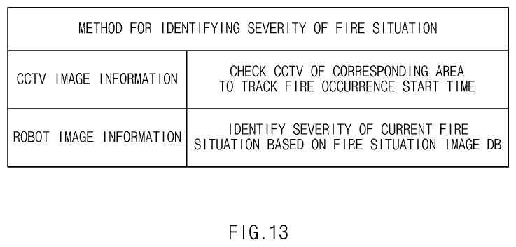

FIG. 12 illustrates a flowchart for describing an operating method of a dangerous situation response system using a plurality of robots according to another embodiment of the present disclosure. FIG. 13 illustrates a drawing for describing in detail S303 of FIG. 12.

Hereinafter, a description will be given of a method in which a dangerous situation response system 1000 operates if a fire occurs in a control zone with reference to FIGS. 12 to 13.

First of all, referring to FIG. 12, in S301, a control system CS may be configured to detect whether a fire situation occurs in a control zone based on data sensed by a plurality of robots 400-1 to 400-n, which is received from a robot management device 400. If detecting that the fire occurs in the control zone (S301—YES), in S302, the control system CS may be configured to allow the robot management device 400 to control a robot corresponding to the zone where the occurrence of the fire is detected in the control zone (hereinafter referred to a “fire detection robot”) among the plurality of robots 400-1 to 400-n to approach within a predetermined range from a point where the fire occurs.

Next, in S303, the control system CS may be configured to receive image data sensed by the fire detection robot as the fire detection robot approaches a zone where the occurrence of the fire is detected and may identify severity of a fire situation based on the received image data. Furthermore, in S304, the control system CS may be configured to determine whether the fire situation is correct based on the image data transmitted by the fire detection robot. If it is determined that the fire situation is not correct (S304—NO), in S300, the control system CS may be configured to allow the fire detection robot to return to a patrol waiting zone via the robot management device 400. On the other hand, if the control system CS determines that the fire situation is correct (S304—YES), in S305, the fire detection robot may be configured to transmit a control notification to the control system CS via the robot management device 400 and may be configured to report a situation to an external agency 2000 via the control system CS.

Next, in S306, the control system CS which receives the control notification from the robot management device 400 may be configured to cancel patrol schedules of all robots. In S307, the control system CS may be configured to allow the robot management device 400 to track movement of a person within the control zone of the plurality of robots 400-1 to 400-n based on CCTV image information received from a building management device 3000 and robot image information received from the robot management device 400. Next, if the motion of the person is detected, in S308, the control system CS may be configured to allow the robot management device 400 to control the plurality of robots 400-1 to 400-n to re-execute a patrol near a zone where the movement is detected. Next, in S309, the plurality of robots 400-1 to 400-n may be configured to approach the object, the movement of which is detected, to guide the object to an evacuation route and may guide a rescue worker of the external agency 2000 to locations of persons needing rescue in real time.

Next, referring to FIG. 13, in S303, the control system CS may be configured to identify severity of a fire situation based on image data sensed by the fire detection robot as the fire detection robot approaches the zone where the occurrence of the fire is detected and CCTV image information obtained from the building management device 3000. For example, the control system CS may be configured to check a past CCTV image of the zone where the occurrence of the fire is detected in S301 and may track a time point when the fire starts to occur.

In some embodiments, the control system CS may be configured to receive image data collected by each of the plurality of robots 400-1 to 400-n when a fire occurred in the control zone in the past and may analyze the image data to construct a database (or robot image information) about an image of the occurrence of the fire. The control system CS may be configured to compare the fire situation image stored in the database about the image of the fire situation with the image data sensed by the fire detection robot as the fire detection robot approaches the zone where the occurrence of the fire is detected to identify severity of the current fire situation.

As such, the dangerous situation response system 1000, according to an exemplary embodiment of the present disclosure, may be configured to determine and respond to a risk level of the fire situation which occurs in the control zone by means of one patrol robot based on past monitoring data (e.g., CCTV image information, robot image information, or the like).

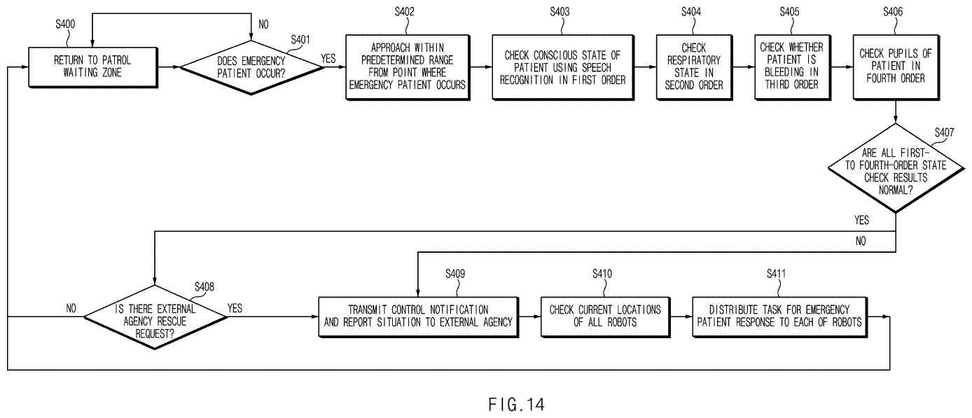

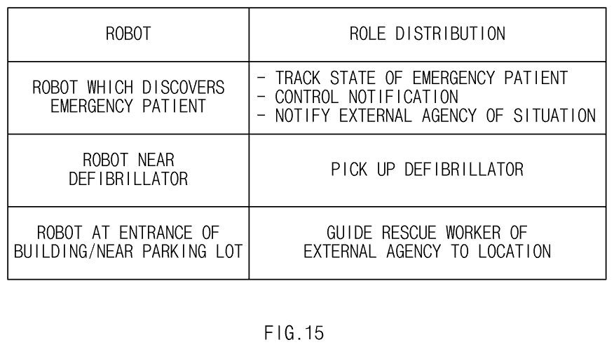

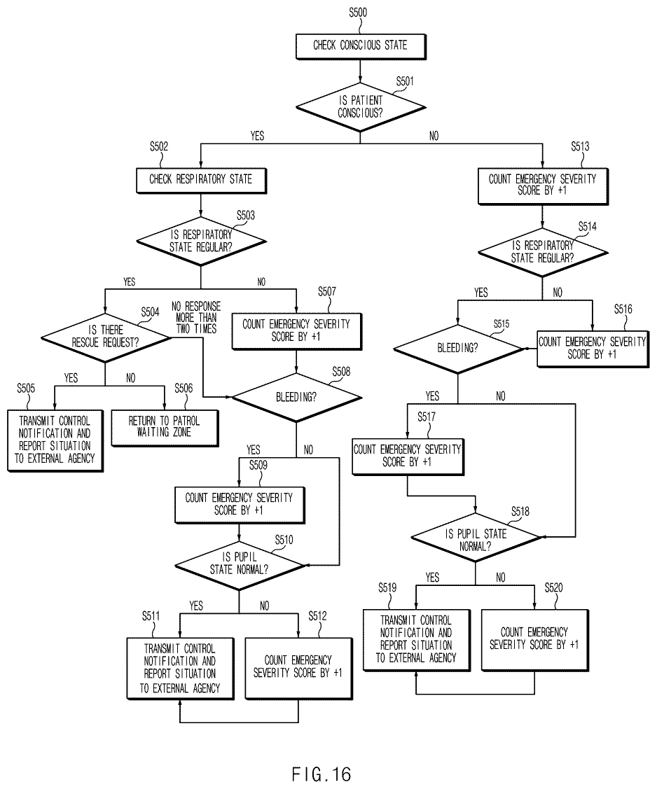

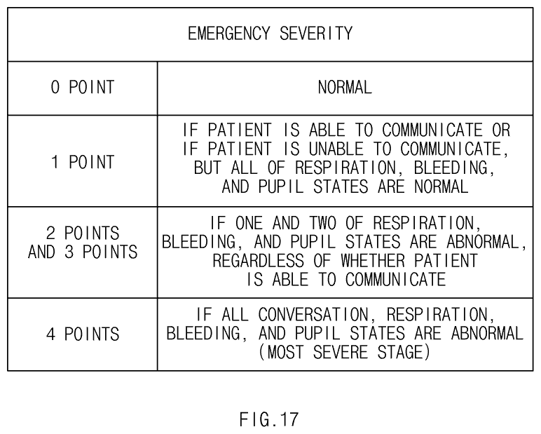

FIG. 14 illustrates a flowchart for describing an operating method of a dangerous situation response system using a plurality of robots according to another embodiment of the present disclosure. FIG. 15 illustrates a drawing for describing in detail S411 of FIG. 14. FIG. 16 illustrates a flowchart for describing an operating method of a dangerous situation response system using a plurality of robots according to another embodiment of the present disclosure. FIG. 17 illustrates a drawing for describing an emergency severity score in a method of FIG. 16.

Hereinafter, a description will be given of a method in which a dangerous situation response system 1000 operates if an emergency patient occurs in a control zone with reference to FIGS. 14 to 17.

First of all, referring to FIG. 14, in S401, a control system CS may be configured to detect whether an emergency patient occurs in a control zone based on data sensed by a plurality of robots 400-1 to 400-n, which is received from a robot management device 400. For example, the plurality of robots 400-1 to 400-n may be configured to check whether there is an object (e.g., a person lying on the floor) defined as the emergency patient based on a raw image sensed by an image sensor. If detecting that the emergency patient does not occur (S401—NO), in S400, the control system CS may be configured to control the plurality of robots 400-1 to 400-n to return to a patrol waiting zone.

Meanwhile, if detecting that the emergency patient occurs (S401—YES), in S402, the control system CS may be configured to allow the robot management device 400 to control a robot corresponding to a zone where it is detected that the emergency patient occurs (hereinafter referred to as an “emergency patient detection robot”) among the plurality of robots 400-1 to 400-n to approach within a predetermined range from a point where the emergency patient occurs. Next, in S403, the emergency patient detection robot may be configured to check a conscious state of the patient using speech recognition in a first order. For example, the emergency patient detection robot may be configured to check reaction of the object in such a manner as to ask a question to the object or may be configured to check a conscious state of the patient in such a manner as to check identification of the object. Next, in S404, the emergency patient detection robot may be configured to check a respiratory state of the patient using visual recognition in a second order. For example, the emergency patient detection robot may be configured to check whether the chest of the object is regularly moving up and down to check the respiratory state of the patient.

Next, in S405, the emergency patient detection robot may be configured to check whether the patient is bleeding in a third order using visual recognition. For example, the emergency patient detection robot may be configured to determine whether the object is bleeding via a manner which visually checks a body of the object and a floor state. Next, in S406, the emergency patient detection robot may be configured to check the pupils of the patient in a fourth order using visual recognition. For example, the emergency patient detection robot may be configured to check the pupils of the object in such a manner as to compare whether the pupils of the patient are open or sizes of the left and right pupils of the patient. The emergency patient detection robot may be configured to transmit the pieces of data ensured via the speech recognition or the visual recognition to the control system CS via the robot management device 400.

Next, in S407, the control system CS may be configured to determine whether all the first-to fourth-order state check results are normal based on the data received from the robot management device 400. If it is determined that all the first-to fourth-order state check results are normal (S407—YES), in S408, the control system CS may be configured to allow the emergency patient detection robot to check whether there is an external agency rescue request from the patient via the robot management device 400. If receiving data indicating that there is no external agency rescue request of the patient from the robot management device 400 (S408—NO), in S400, the control system CS may be configured to control the plurality of robots 400-1 to 400-n to return to the patrol waiting zone.

On the other hand, if receiving data indicating that there is the external agency rescue request of the patient from the emergency patient detection robot or receiving data indicating that there is no response from the patient (S408—YES), in S409, the robot management device 400 may be configured to transmit a control notification to the control system CS and may be configured to report a situation to the external agency 2000 in response to receiving the control notification from the robot management device 400.

Meanwhile, if it is determined that at least one of the first-to fourth-order state check results is abnormal (S407—NO), in S409, the control system CS may be configured to report a situation to the external agency 2000. As such, if receiving the data indicating that there is the external agency rescue request of the patient from the emergency patient detection robot or receiving the data indicating that there is no response from the patient or it is determined that the at least one of the first-to fourth-order state check results is abnormal, in S410, the control system CS may be configured to check current locations of all robots in the control zone. Next, in S411, the control system CS may be configured to distribute a task for emergency patient response to each of the robots 400-1 to 400-n. Thereafter, if the situation of the occurrence of the emergency patient ends, in S400, the control system CS may be configured to control the plurality of robots 400-1 to 400-n to return to the patrol waiting zone.

Next, a description will be given of the operation of distributing the task for the emergency patient response to each of the robots 400-1 to 400-n in the control system CS in S411.

Referring to FIG. 15, a determination device 200 of the control system CS may be configured to determine a situation in which the plurality of robots 400-1 to 400-n are able to collaborate with one another based on current locations of the plurality of robots 400-1 to 400-n in the control zone, current remaining battery capacities of the plurality of robots 400-1 to 400-n, and data about a task which is currently in progress by each of the plurality of robots 400-1 to 400-n, in response to receiving the control notification including information indicating that the state of the emergency patient is abnormal from the event detection device 100. The distribution device 300 may be configured to distribute tasks for emergency patient response to the plurality of robots 400-1 to 400-n as the determined result of the determination device 200.

For example, the distribution device 300 may be configured to track a state of the emergency patient, may be configured to transmit a control notification to the control system CS, and/or may be configured to distribute a task for transmitting a notification to the external agency 2000 to a robot which discovers the emergency patient among the plurality of robots 400-1 to 400-n. Furthermore, the distribution device 300 may be configured to distribute a task for picking up a defibrillator to a robot located near the defibrillator identified based on the current location of each of the plurality of robots 400-1 to 400-n among the plurality of robots 400-1 to 400-n. Furthermore, the distribution device 300 may be configured to distribute a task for guiding a rescue worker of the external agency 2000 to a location to a robot located at the entrance of a building or near a parking lot, which is identified based on the current location of each of the plurality of robots 400-1 to 400-n.

As such, the dangerous situation response system 1000, according to an exemplary embodiment of the present disclosure, may be configured to control operation of the plurality of robots 400-1 to 400-n to collaborate with one another to respond to a dangerous situation using the plurality of robots 400-1 to 400-n based on a current state (e.g., a current location, a current remaining battery capacity, a type of a task which is currently in progress, or the like) of each of the plurality of robots 400-1 to 400-n.

Meanwhile, if transmitting the control notification to the control system CS in S409 of FIG. 14, the robot management device 400 may be configured to transmit an emergency severity score together. Hereinafter, a description will be given of an operation of identifying a state of a patient using speech recognition and visual recognition and counting an emergency severity score based on the identified result in an emergency patient detection robot under control of the robot management device 400 together with reference to FIGS. 16 and 17.

First of all, in S500, the emergency patient detection robot may be configured to check a conscious state of the patient using speech recognition. If it is determined that the patient is conscious (S501—YES), in S502, the emergency patient detection robot may be configured to check a respiratory state of the patient. If it is determined that the respiratory state is regular as a result of checking the respiratory state of the patient (S503—YES), in S504, the emergency patient detection robot may be configured to determine whether there is a rescue request of the patient. At this time, if it is determined that there is the rescue request of the patient (S504—YES), in S505, the control system CS may be configured to transmit a control notification to the control system CS via the robot management device 400 and the control system CS may be configured to report a situation to the external agency 2000 in response to receiving the control notification.

On the other hand, if it is determined that there is no rescue request of the patient (S504—NO), in S506, the robot management device 400 may be configured to control the emergency patient detection robot to return to a patrol waiting zone. Meanwhile, if the patient does not respond two times or more when the emergency patient detection robot asks the patient if he or she needs a rescue request (S504—no response more than two times), in S508, the emergency patient detection robot may be configured to check whether the patient is bleeding via visual recognition.

Furthermore, if it is determined that the respiratory state is not regular as a result of checking the respiratory state of the patient (S503—NO), in S507, the emergency patient detection robot may be configured to count and store an emergency severity score of the patient by +1 in a counter circuit. Next, in S508, the emergency patient detection robot may check whether the patient is bleeding via visual recognition.

Furthermore, if it is determined that the patient is bleeding via the visual recognition (S508—YES), in S509, the emergency patient detection robot may be configured to count and store the emergency severity score of the patient by +1 in the counter circuit. Next, in S510, the emergency patient detection robot may be configured to determine whether a pupil state of the patient is normal via visual recognition. Meanwhile, if it is determined that the patient is not bleeding via the visual recognition (S508—NO), in S510, the emergency patient detection robot may be configured to determine whether the pupil state of the patient is normal via visual recognition.

If it is determined that the pupil state of the patient is normal (S510—YES), in S511, the emergency patient detection robot may be configured to transmit a control notification to the control system CS via the robot management device 400 and the control system CS may be configured to report a situation to the external agency 2000. On the other hand, if determining that the pupil state of the patient is abnormal (S510—NO), in S512, the emergency patient detection robot may be configured to count and store the emergency severity score of the patient by +1 in the counter circuit. Next, in S511, the emergency patient detection robot may be configured to transmit a control notification to the control system CS via the robot management device 400 and the control system CS may be configured to report a situation to the external agency 2000. If transmitting the control notification to the control system CS in S511, the robot management device 400 may be configured to transmit data about the emergency severity score of the patient, which is stored in the counter circuit of the emergency patient detection robot, together.

Meanwhile, in S500, the emergency patient detection robot may be configured to check the conscious state of the patient using the speech recognition. If determining that the patient is not conscious or it is unable to determine whether the patient is conscious (S501—NO), in S513, the emergency patient detection robot may be configured to count and store the emergency severity score of the patient by +1 in the counter circuit. Next, in S514, the emergency patient detection robot may be configured to check whether the respiratory state of the patient is regular via the visual recognition. If it is determined that the respiratory state of the patient is regular (S514—YES), in S515, the emergency patient detection robot may be configured to check whether the patient is bleeding via visual recognition.

Meanwhile, if determining that the respiratory state of the patient is not regular or that it is unable to determine whether the respiratory state of the patient is regular (S514—NO), in S516, the emergency patient detection robot may be configured to count and store the emergency severity score of the patient by +1 in the counter circuit. Thereafter, in S515, the emergency patient detection robot may be configured to check whether the patient is bleeding via visual recognition.

If determining that the patient is bleeding or that it is unable to determine whether the patient is bleeding (S514—YES), in S517, the emergency patient detection robot may be configured to count and store the emergency severity score of the patient by +1 in the counter circuit. Next, in S518, the emergency patient detection robot may be configured to determine whether the pupil state of the patient is normal. Meanwhile, if it is determined that the patient is not bleeding (S515—NO), in S518, the emergency patient detection robot may be configured to determine whether the pupil state of the patient is normal.

If it is determined that the pupil state of the patient is normal (S518—YES), in S519, the emergency patient detection robot may be configured to transmit a control notification to the control system CS via the robot management device 400 and the control system CS may be configured to report a situation to the external agency 2000. On the other hand, if determining that the pupil state of the patient is abnormal (S518—NO), in S520, the emergency patient detection robot may be configured to count and store the emergency severity score of the patient by +1 in the counter circuit. Next, in S519, the emergency patient detection robot may be configured to transmit a control notification to the control system CS via the robot management device 400 and the control system CS may be configured to report a situation to the external agency 2000. If transmitting the control notification to the control system CS in S519, the robot management device 400 may be configured to transmit data about the emergency severity score of the patient, which is stored in the counter circuit of the emergency patient detection robot, together.

Next, referring to FIG. 17, the control system CS may be configured to identify a severe emergency degree of the patient based on the emergency severity score of the patient, which is received from the robot management device 400. For example, if the emergency severity score is 0 point, the control system CS may be configured to determine that the patient is in a normal state rather than an emergency state. For example, if the emergency severity score is 1 point, the control system CS may be configured to determine that the patient is able to communicate or that the patient is unable to communicate, but all of respiration, bleeding, and pupils are in a normal state. If the emergency severity score is 2 points or 3 points, the control system CS may be configured to determine that one and two of the respiration, the bleeding, and the pupils are in an abnormal state, regardless of whether the patient is able to communicate. If the emergency severity score is 4 points, the control system CS may be configured to determine that all the conversation, the respiration, the bleeding, and the pupils are in the abnormal state.

If distributing the task for the emergency patient response to each of all the robots 400-1 to 400-n in the control zone in S411, the control system CS may be configured to distribute the task to each robot based on the emergency severity degree of the patient, which is identified from the emergency severity score of the patient. As such, the dangerous situation response system 1000, according to an exemplary embodiment of the present disclosure, may be configured to distribute the task such that the plurality of robots collaborate with one another based on the emergency severity degree of the patient, which is identified via the speech recognition or the visual recognition of the patrol robot.

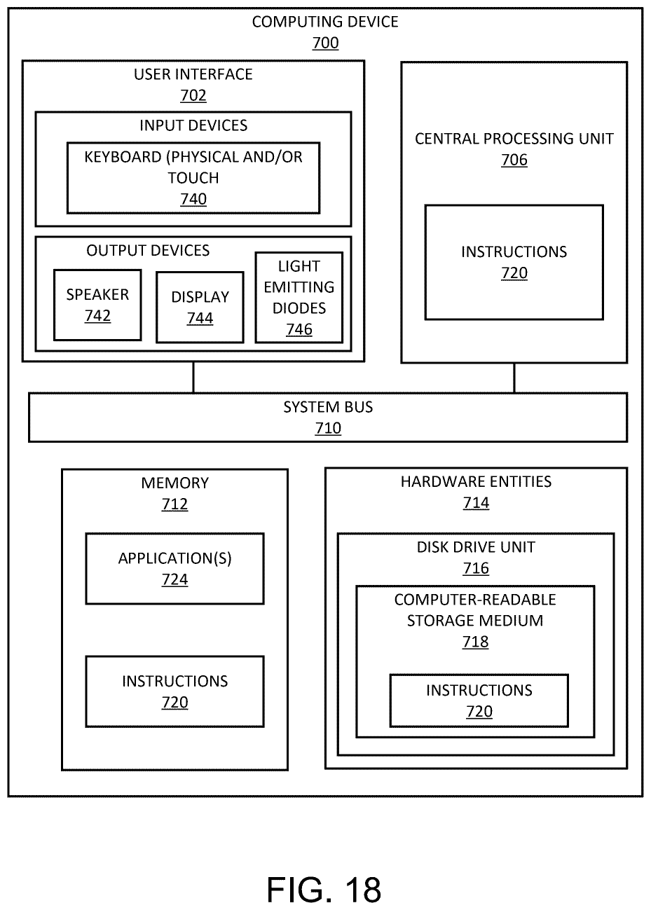

Referring now to FIG. 18, an illustration of an example architecture for a computing device 700 is provided. According to an exemplary embodiment, one or more functions of the present disclosure may be implemented by a computing device such as, e.g., computing device 700 or a computing device similar to computing device 700. Computing device 700 may be a quantum computer, a classical computer, and/or have one or more components configured to perform one or more quantum and/or classical computing functions. Control system CS, event detection device 100, determination device 200, distribution device 300, robot management device 400, robots 400-1 to 400-n, the one or more response robots and/or emergency patient detection robots, dangerous situation response system 1000, and/or building management device 3000 may be an example of computing device 700 and/or may comprise one or more components of computing device 700.

The hardware architecture of FIG. 18 represents one example implementation of a representative computing device configured to implement at least a portion of the systems/devices and method(s)/control logic(s) described herein.

Some or all components of the computing device 700 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 18, the computing device 700 may comprise a user interface 702 (e.g., a graphical user interface), a Central Processing Unit (“CPU”) 706, a system bus 710, a memory 712 connected to and accessible by other portions of computing device 700 through system bus 710, and hardware entities 714 connected to system bus 710. The user interface may comprise input devices and output devices, which may be configured to facilitate user-software interactions for controlling operations of the computing device 700. The input devices may comprise, but are not limited to, a physical and/or touch keyboard 740. The input devices may be connected to the computing device 700 via a wired or wireless connection (e.g., a Bluetooth® connection). The output devices may comprise, but are not limited to, a speaker 742, a display 744, and/or light emitting diodes 746.

At least some of the hardware entities 714 may be configured to perform actions involving access to and use of memory 712, which may be a Random Access Memory (RAM), a disk driver and/or a Compact Disc Read Only Memory (CD-ROM), among other suitable memory types. Hardware entities 714 may comprise a disk drive unit 716 comprising a computer-readable storage medium 718 on which may be stored one or more sets of instructions 720 (e.g., programming instructions such as, but not limited to, software code) configured to implement one or more of the methodologies, procedures, or functions described herein. The instructions 720 may also reside, completely or at least partially, within the memory 712 and/or within the CPU 706 during execution thereof by the computing device 700.

The memory 712 and the CPU 706 may also constitute machine-readable media. The term “machine-readable media”, as used here, refers to a single medium or multiple media (e.g., a centralized or distributed database, and/or associated caches and servers) that store the one or more sets of instructions 720. The term “machine-readable media”, as used here, also refers to any medium that is capable of storing, encoding, or carrying a set of instructions 720 for execution by the computing device 700 and that cause the computing device 700 to perform any one or more of the methodologies of the present disclosure. According to various embodiments, one or more computer applications 724 may be stored on the memory 712.

The present technology may be configured to distribute tasks such that several patrol robots are able to perform different tasks to collaborate with one another based on state information, such as current locations of the several patrol robots for a dangerous situation which occurs in a specific zone, thus increasing efficiency of dangerous situation response.

Furthermore, the present technology may be configured to increase the accuracy of determining the dangerous situation which occurs in the specific zone using real-time image data of the specific zone and image data collected by the patrol robot.

Furthermore, the present technology may be applied to a robot-friendly building in which several robots coexist.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A dangerous situation response system, comprising:
a plurality of robots respectively corresponding to a plurality of zones and configured to operate, respectively, in the plurality of zones,
wherein the plurality of zones are separated from each other;
a robot management device configured to control operation of each of the plurality of robots; and
a control system configured to receive image data collected by at least one robot, among the plurality of robots, from the robot management device,
wherein the control system comprises:
an event detection device configured to detect whether a dangerous situation has occurred in any one of the plurality of zones based on the received image data;
a determination device configured to determine a situation in which the plurality of robots are able to collaborate with one another based on data about current states of the plurality of robots, the data being received from the robot management device; and
a distribution device configured to distribute a task to the at least one robot, among the plurality of robots, based on the determined situation.

2. The dangerous situation response system of claim 1, wherein:
the robot management device is configured to transmit data about a current location of the at least one robot, among the plurality of robots, to the determination device, and
the determination device is configured to determine the situation in which the plurality of robots are able to collaborate with one another based on the received data about the current location of the robot.

3. The dangerous situation response system of claim 1, wherein:
the robot management device is configured to transmit data about a current remaining battery capacity of the at least one robot, among the plurality of robots, to the determination device, and
the determination device is configured to determine the situation in which the plurality of robots are able to collaborate with one another based on the received data about the current remaining battery capacity of the robot.

4. The dangerous situation response system of claim 1, wherein:
the robot management device is configured to transmit data about a task of the at least one robot, among the plurality of robots, the task being currently in progress, to the determination device; and
the determination device is configured to determine the situation in which the plurality of robots are able to collaborate with one another based on the received data about the task of the robot, the task being currently in progress.

5. The dangerous situation response system of claim 1, wherein the robot management device is configured to:
receive the collected image data from each of the plurality of robots;
construct a database about a frequency at which face data present in the received image data appears in zones respectively corresponding to the plurality of robots; and
compare the face data stored in the database with face data recognized in real time by the at least one robot among the plurality of robots to respond to an object recognized by the at least one robot in a corresponding zone of the at least one robot.

6. The dangerous situation response system of claim 5, wherein the robot management device is configured to allow the at least one robot to request to register an ID in response to a frequency of appearance of the face data, recognized in real time by the at least one robot, the frequency of appearance being identified from the database and greater than or equal to a predetermined threshold.

7. The dangerous situation response system of claim 5, wherein the robot management device is configured to allow the at least one robot to transmit a warning message to the object and guide the object to register access, in response to a frequency of appearance of the face data, recognized in real time by the at least one robot, the frequency of appearance being identified from the database, less than a predetermined threshold, and greater than “0”.

8. The dangerous situation response system of claim 5, wherein the robot management device is configured to transmit a notification signal to the control system and determine an expected path of the object, in response to a frequency of appearance of the face data, recognized in real time by the at least one robot, the frequency of appearance being identified from the database as “0”.

9. The dangerous situation response system of claim 8, wherein the robot management device is configured to:
determine whether there is another robot, different from the at least one robot, on the determined expected path of the object;
transmit face data of the object to the other robot, in response to it being determined that the other robot is on the expected path; and
request the other robot to follow the object and utter a warning message to the object.

10. The dangerous situation response system of claim 8, wherein the robot management device is configured to:
determine whether there is another robot different from the at least one robot on the determined expected path of the object; and
allow the at least one robot to follow the object and utter a warning message to the object, in response to it being determined that there is no other robot on the expected path.

11. An operating method of a dangerous situation response system, the operating method comprising:
providing a plurality of robots respectively corresponding to a plurality of zones and operating in the respectively corresponding zones,
wherein the plurality of zones are separated from each other;
controlling, by a robot management device, operation of each of the plurality of robots;
collecting, by at least one robot among the plurality of robots, image data;
transmitting, by the at least one robot, the image data to the robot management device;
transmitting, by the robot management device, the image data to a control system;
detecting, by an event detection device of the control system, whether a dangerous situation has occurred in any one of the plurality of zones, based on the image data;
determining, by a determination device of the control system, a situation in which the plurality of robots are able to collaborate with one another based on data about current states of the plurality of robots, the data being received from the robot management device; and
distributing, by a distribution device of the control system, a task to the at least one robot, among the plurality of robots, based on the determined situation.

12. The operating method of claim 11, further comprising transmitting, by the robot management device, data about a current location of the at least one robot among the plurality of robots to the determination device,
wherein the determining of the situation in which the plurality of robots are able to collaborate with one another by the determination device comprises determining the situation in which the plurality of robots are able to collaborate with one another based on the received data about the current location of the robot.

13. The operating method of claim 11, further comprising transmitting, by the robot management device, data about a current remaining battery capacity of the at least one robot among the plurality of robots to the determination device,
wherein the determining of the situation in which the plurality of robots are able to collaborate with one another by the determination device comprises determining the situation in which the plurality of robots are able to collaborate with one another based on the received data about the current remaining battery capacity of the robot.

14. The operating method of claim 11, further comprising transmitting, by the robot management device, data about a task of the at least one robot among the plurality of robots, the task being currently in progress, to the determination device,
wherein the determining of the situation in which the plurality of robots are able to collaborate with one another by the determination device comprises determining the situation in which the plurality of robots are able to collaborate with one another based on the received data about the task of the robot, the task being currently in progress.

15. The operating method of claim 11, further comprising:
constructing, by the robot management device, a database about a frequency at which face data present in the image data appears in a zone corresponding to the at least one robot;
comparing, by the robot management device, the face data stored in the database with face data recognized in real time by the at least one robot; and
responding, by the robot management device, to an object recognized by the at least one robot in a corresponding zone of the at least one robot, based on the compared result.

16. The operating method of claim 15, further comprising:
allowing, by the robot management device, the at least one robot to request to register an ID, in response to a frequency of appearance of the face data, recognized in real time by the at least one robot, the frequency of appearance being identified from the database and greater than or equal to a predetermined threshold; or
allowing, by the robot management device, the at least one robot to transmit a warning message to the object and guide the object to register access, in response to the frequency of appearance of the face data recognized in real time by the at least one robot, the frequency of appearance being identified from the database, less than a predetermined threshold, and greater than “0”.

17. The operating method of claim 15, further comprising transmitting, by the robot management device, a notification signal to the control system and determining, by the robot management device, an expected path of the object, in response to a frequency of appearance of the face data, recognized in real time by the at least one robot, the frequency of appearance being identified from the database as “0”.

18. The operating method of claim 17, further comprising:
determining, by the robot management device, whether there is another robot, different from the at least one robot, on the determined expected path of the object;
transmitting, by the robot management device, face data of the object to the other robot, in response to it being determined that there is the other robot on the expected path; and
requesting, by the robot management device, the other robot to follow the object and utter a warning message to the object.

19. The operating method of claim 17, further comprising:
determining, by the robot management device, whether there is another robot, different from the at least one robot, on the determined expected path of the object; and
allowing, by the robot management device, the at least one robot to follow the object and utter a warning message to the object, in response to it being determined that there is no other robot on the expected path.

20. A dangerous situation response system, comprising:
a plurality of robots respectively corresponding to a plurality of zones and configured to operate, respectively, in the plurality of zones,
wherein the plurality of zones are separated from each other; and
a computing device comprising a processor and a memory, wherein the memory is configured to store instructions that, when executed by the processor, are configured to cause the processor to:
control operation of each of the plurality of robots;
receive image data collected by at least one robot, among the plurality of robots;
detect whether a dangerous situation has occurred in any one of the plurality of zones based on the received image data;
determine a situation in which the plurality of robots are able to collaborate with one another based on data about current states of the plurality of robots; and
distribute a task to the at least one robot, among the plurality of robots, based on the determined situation.
